(19) United States
(12) Patent Application Publication
(10) Pub. No.: US 2002/0190167 A1
(43) Pub. Date: Dec. 19, 2002

(54) Apparatus for supporting a model aerospace craft

(76) Inventor: Albert R. Rodriguez, Houston, TX (US)

Correspondence Address: Jo Katherine D'Ambrosia, D'Ambrosio & Associates PLLC, 2925 Briar Park, Suite 930, Houston, TX, 77042, US

(21) Appl. No.: 09/881,612

(22) Filed: Jun. 13, 2001

(51) Int. Cl. F16M 11/00

(52) U.S. Cl. 248/176.1; 248/181.1

(57) ABSTRACT

The apparatus for supporting a model aerospace craft in multiple positions comprises a pedestal, an upright stand, a ball within a socket assembly, and attaching means adapted to attach the apparatus to the aerospace craft. The pedestal provides a base support for the apparatus. In one embodiment the pedestal can comprise a flat base. In another embodiment the pedestal comprises a base tripod.

The upright stand is attached to the pedestal at its first end and attached to the ball/socket assembly at its second end to support the ball and socket assembly and its attached model aerospace vehicle. In one embodiment the upright stand comprises a shaft or support column. Alternatively, the upright stand can comprise a tripod. The ball/socket assembly is adapted to rotate the fuselage of the aerospace vehicle in three planes, longitudinal plane, lateral plane and vertical plane to simulate pitch, yaw and roll of an aerospace craft.

### FIELD OF THE INVENTION

This invention relates to an apparatus for supporting a model aerospace craft in multiple positions.

### BACKGROUND OF INVENTION

The hobby of assembling and displaying model aircraft has grown and now includes the display of fighter planes, commercial aircraft, helicopters and space vehicles. Stands are used to mount and display the model air and space crafts. Typically the stands are static and do not allow for realistic positioning of the crafts. Stands to adjustably mount other objects, eye glasses, lamps or hats have been disclosed.

U.S. Pat. No. 791,682 to Fall discloses an adjustable display stand for hats. The '682 patent teaches a rack for holding hats or other articles on a vertically moveable mount. The Fall patent allows movement only along a vertical axis. Faase et al., U.S. Pat. No. 2,871,868, teaches an adjustable mount for an umbrella. The Faase patent discloses the use of a universal joint with tightening means allowing the umbrella limited movement in all directions.

Ford & Alexander, U.S. Pat. No. 560,092, disclose a support for the combination of a gas-pipe and a blowpipe. As described in the '092 patent, a vertically adjustable portion has a double ball and socket adjustment for limited movement in other axes. The patent also discloses having a clamp to hold the blowpipes.

U.S. Pat. No. 94,712 to Chinnock describes an improved toilet mirror. In the '712 patent, the base upon which the mirror is mounted is disclosed as being held in place by a friction force created by two spring-loaded plates. The Chinnock patent discloses that the toilet mirror is adjustable by means of springs in combination with a projecting arm and has a swivel motion on the post of a stand.

Campo discloses a general utility lamp in U.S. Pat. No. 2,618,451. The lamp has a base or support (the standard) and a housing that is swivelly connected to the standard. The '451 patent comprises a vertically adjustable post and a slidably engagable and swivelly supported arm. The arm is disclosed as being able to swing in the horizontal axis. The Campo patent discloses a ball 21 that is snapped into a socket for the swivel movement. Also disclosed is a pin positioned in the socket to control the swivel movement. The '451 patent also teaches the use of a swivelly mounted clamp. According to the Campo disclosure, the lamp has a limited ability to move in several directions.

Different types of attachment members have been used over the years in relation to support stands. U.S. Pat. No. 2,948,500 was given to Kuhn for a device for carrying articles on display. The '500 patent teaches an apparatus for holding eyeglasses on display. The device comprises a base, an elongated support member, a single strip-shaped attachment member, and a ball and joint for connecting the attaching member to the supporting member. The supporting member has the attachment means for holding eyeglasses.

Meinel was granted U.S. Pat. No. 5,769,369 for a mobile office stand used to support a portable computer or electronic organizer in vehicles. The '369 patent discloses an ergonomically designed workstand for electronic devices. The apparatus includes a generally rectangular shaped cradle for retaining the device. The computer stand has at least one pair of opposed jaw members attached by tensioned springs. The base on the stand comprises a universal ball and socket, swivel, or other ratchet joint to attach the base to the cradle.

The ability to illuminate items on a stand with an adjustable light has been accomplished different ways over the years. Ingwer et al. in U.S. Pat. No. 2,271,974 discloses an adjustable sewing machine light. The lamp is held by an angularly bent end. The clamp used to secure the lamp is disclosed as having two interfitting U-shaped members, slidably engaged over the top of a ball head. The two U-shaped members are held in position on the ball and apply positive pressure against the ball creating a secure hold.

Aerospace craft are dynamic vehicles. Owners of the model aircraft often wish to mount and display model aerospace vehicles on a realistic and non-static stand. A need exists for a model aerospace vehicle stand that allows model aerospace vehicles of different types of materials and weights to be displayed in a variety of realistic positions.

### SUMMARY OF THE INVENTION

The present invention relates to an apparatus for supporting and displaying a model aerospace craft of different types of materials and weights in multiple positions. Model aerospace crafts or vehicles, including planes, helicopters, and spacecraft such as rocket launchers and rocket ships, are presently held upright by model stands or hung from their wings. Authentic aircraft are capable of motion along three axis, pitch, yaw and roll. The present invention comprises a novel apparatus that allows support and realistic display of the aircraft along the three axes simultaneously. Preferably, the apparatus can be sized to uphold different size and shape model aerospace crafts.

In one preferred embodiment, the apparatus comprises a pedestal, an upright stand, a ball within a socket assembly, and an attaching means to attach the ball to the aerospace craft. The pedestal provides a base support for the apparatus. In one embodiment the pedestal is comprised of a flat base. In another embodiment the pedestal comprises a base tripod.

The upright stand is attached to the pedestal at its first end and attached to a ball within a socket assembly at its second end so as to support the ball and socket assembly with a model aircraft attached. In one embodiment, the upright stand comprises a supporting column or shaft. Alternatively, the upright stand can comprise a tripod. In still another embodiment the upright stand comprises a slidably adjustable shaft within a tripod for varying the height of the apparatus. In another embodiment, the upright stand comprises a tube and a rod assembly. The rod can telescope within the tube so that the height of the apparatus and its attached model aerospace craft can be varied.

The ball/socket assembly is adapted to rotate the fuselage of the aerospace vehicle in three planes, longitudinal plane, lateral plane and vertical plane to simulate pitch (y axis), yaw (z axis) and roll (x axis). One preferred embodiment comprises a ball that rotates up to 180° within the socket so as to position the model aerospace craft along lateral, longitudinal, and vertical axes. In another embodiment, the ball can rotate up to 360° along the yaw axis and the limit of rotation along the pitch and roll axes is determined by the position of the attaching means on the ball. The ball within a socket is adapted to rotate the model aerospace vehicle in three planes for display of the vehicle to simulate the pitch, roll and yaw of an aircraft's movement.

An attachment means is connected to the ball within a socket to fixedly attach the fuselage or wings of the model aerospace vehicle to the ball of the ball/socket assembly. Different attachment means can be used to attach the model aerospace craft to the apparatus depending on the size and weight of the model. One preferred embodiment has a manually adjustable clamp to attach the fuselage of the model aerospace vehicle to the ball/socket assembly. In an alternative embodiment, the attachment means comprises two or more prongs, one end of each prong fixedly attached to a separate ball within the socket assembly. The other end of each prong is adapted to attach to the fuselage of the model aerospace vehicle. In this way, each prong rotates independently.

Another attachment means preferably comprises a magnetic strip used with a magnetic metal bar. The magnetic strip is fixedly attached to the ball within the socket. The magnetic metal bar is attached to the fuselage of the aircraft. An alternative embodiment has a means of attachment comprising a spring-loaded clamp. Another alternative embodiment of this invention uses a quick release plate and mount for attaching the aircraft to the ball within a socket. In one preferred embodiment, the apparatus for supporting a model aerospace craft further comprises a light source.

### BRIEF DESCRIPTION OF THE DRAWINGS

FIG. 1 depicts a three dimensional view of one embodiment of the present invention.

FIG. 2 is a cross-sectional view of one embodiment of the invention illustrating a light attachment.

FIG. 2a is a cross-sectional view of one embodiment of the invention illustrating a telescoping rod.

FIG. 2b is a cross-sectional view of one embodiment of the invention illustrating a hinged stand.

FIG. 3 depicts a three dimensional view of an aircraft showing the three axis of movement.

FIG. 4 depicts a cross-sectional view of another embodiment of the invention.

FIG. 4a is a cross-sectional view of one preferred rotating means of the invention. FIG. 4b is a cross-sectional view of another preferred rotating means of the invention.

FIG. 5a-5f depict various attaching means for attaching the apparatus to an aerospace craft;

FIG. 5a depicts a magnetic strip.

FIG. 5b depicts a spring clamp.

FIG. 5c depicts a quick release plate.

FIG. 5d depicts an adjustable clamp.

FIG. 5e depicts a multiple prong attachment.

FIG. 5f depicts another embodiment of a multiple prong attachment.

FIG. 6 depicts another embodiment of the apparatus for supporting a model aerospace craft.

It is noted that the drawings illustrate only some typical embodiments of the invention and are therefore not to be considered limiting of its scope, for the invention will admit to other equally effective embodiments.

### DETAILED DESCRIPTION OF THE INVENTION

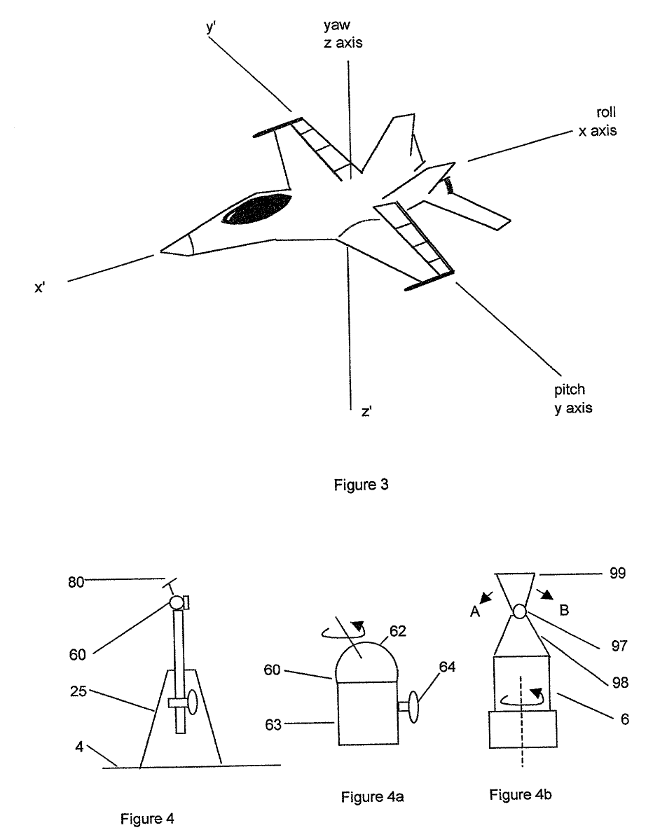

The apparatus of this invention supports and displays model aerospace craft in multiple positions. The collection and display of model aerospace crafts or vehicles, including planes, helicopters, and spacecraft such as rocket launchers and rocket ships, is a very popular hobby. Authenticity is important to collectors of models. Real aircraft are capable of motion along three axis, pitch, yaw and roll as illustrated in FIG. 3. The apparatus for supporting model aerospace craft of the present invention allows a user to simultaneous display the pitch, yaw and roll positioning of model aerospace vehicles. Preferably, the apparatus can be sized to hold many different size and shape model aerospace crafts. The material comprising the model aerospace craft 5 is a factor in the size and shape and material comprising the apparatus of this invention 10. Plastic and wooden crafts 5 are lighter in weight and can be supported by plastic or wooden apparatuses 10. Die cast models 5 are made of metals and require an apparatus 10 that can support the heavier weight, metal or strong plastic for example.

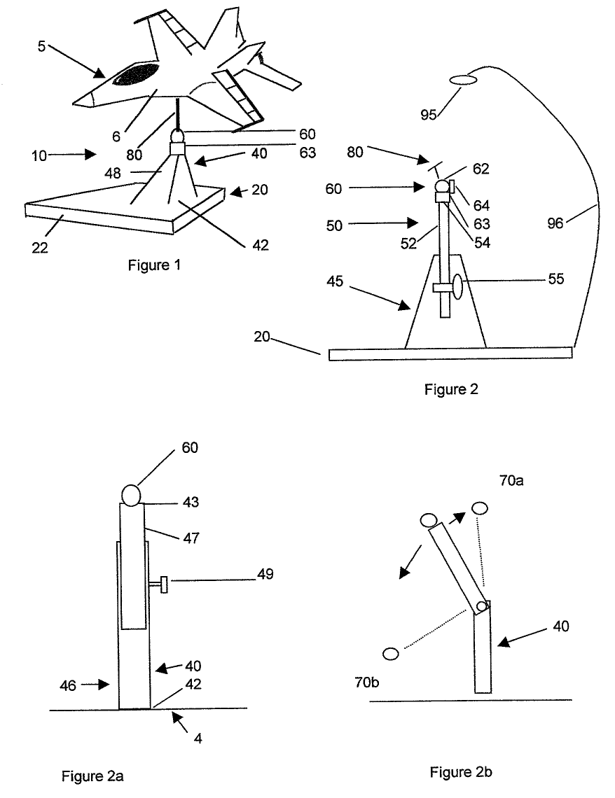

FIG. 1 illustrates a preferred apparatus for supporting a model aerospace craft in multiple positions 10. Referring to FIG. 1, the model aerospace craft 5 comprises a body or fuselage 6. One preferred apparatus supports and displays model aerospace craft by upholding the fuselage. Alternatively, the aerospace craft can be supported by its wings. One preferred apparatus for supporting a model aerospace craft comprises a pedestal 20, an upright stand 40 having a first end 42 attached to the pedestal 20 and a second end 43, a ball within a socket assembly 60 attached to the second end 43 of the upright stand and attaching means 80 adapted to attach the apparatus 10 to a model aerospace craft 5. Another embodiment of the apparatus has a pedestal comprised of height adjustable means. Other embodiments can have both a pedestal and upright stand with height adjustable means.

The pedestal 20 supports and provides stability for the apparatus upon a surface 4 such as a table or desk. In one embodiment, the pedestal 20 comprises a base 22 as shown in FIG. 1. The base 22 can have various shapes, triangular, rectangular, octagal etc., depending on aesthetic preferences. The pedestal 20 can also comprise different sizes of height, width and length. The size and shape of the pedestal 20 can vary as long as the pedestal 20 ultimately supports the weight and size of the model aerospace craft. As such, size and shape are known in the art and varieties in shapes and sizes are within the scope of this invention. In an alternative embodiment, as illustrated in FIG. 4, the pedestal comprises a base tripod 25. The tripod 25 can be adjustable so that the height of the apparatus 10 is variable. One preferred embodiment of the apparatus 10 comprises a pedestal 20 having height adjustable means, an adjustable base tripod 25, for example. Another embodiment can have both a pedestal 25 and upright stand 40 with height adjustable means. Adjustable tripods or slidable shafts are two examples of a means for adjusting the height of the apparatus. Other height adjustable means are known in the art and within the scope of this invention.

Referring to FIGS. 1 and 2, the upright stand 40 is illustrated as a supporting member between the pedestal 20 and the ball/socket assembly 60. Preferably the upright stand 40 comprises a first end 42 attached to the pedestal 20 and a second end 43 connected to the ball and socket assembly 60. The means of attachment depends on the type of material comprising the various components of the apparatus 10. If the apparatus 10 is metal, the upright stand 40 can be soldered to the pedestal 20. Alternatively, the upright stand 40 can be screwed onto the pedestal. Various forms of adhesives are known in the art and can be used to attach the stand 40 to the pedestal 20 if the apparatus 10 comprises wood or plastic. In still another alternative for plastic stands 40 and pedestals 20, the structure of the first end 42 of the upright stand 40 can be modified to snap into an opening in the pedestal 20. In still another alternative, the pedestal 20 and upright stand 40 are integral.

FIG. 1 depicts the upright stand 40 as a support column 48. The column 48 can be solid or hollow, depending on the material and strength required to uphold the model aerospace craft 6. The size and shape of the support column 48 can vary according to the aesthetic preference of the user. The variance is limited to a size and shape required to support the model aerospace craft 5. In another preferred embodiment, the support column 48 can comprise a tube 46 and a rod 47 assembly as depicted in FIG. 2a, the rod 47 telescoping within the tube 46 to vary the height of the apparatus 10. A screw 49 or knob can be tightened to fix the rod 47 within the desired height position within the tube 46. Alternatively as seen in FIG. 2b, the upright stand 40 can be bisected by a hinge 70 to vary the height and position of the model aerospace craft 6 as it rotates through an arc, 70a to 70b. FIG. 2 illustrates still another preferred embodiment wherein the upright stand 40 is a tripod 45. The tripod can be adjustable. Alternatively, the tripod 45 comprises a slidably adjustable shaft 50 within the tripod for varying the height of the apparatus. The shaft 50 can comprise a rod 54 within a tube 52 having a tightening means 55 to hold the position of the rod 54.

FIG. 6 depicts another embodiment of the upright stand 120. In this embodiment, the upright stand comprises a flexible gooseneck support 120 that is movable to simulate movement of an aircraft, pitch, roll and yaw. In this embodiment, the gooseneck support 120 comprises a first end 125 and a second end 126. The first end 125 is attached to the pedestal and the second end can be attached either directly to the fuselage 6 of a model aerospace craft 5 or to an attaching means 80 as described below.

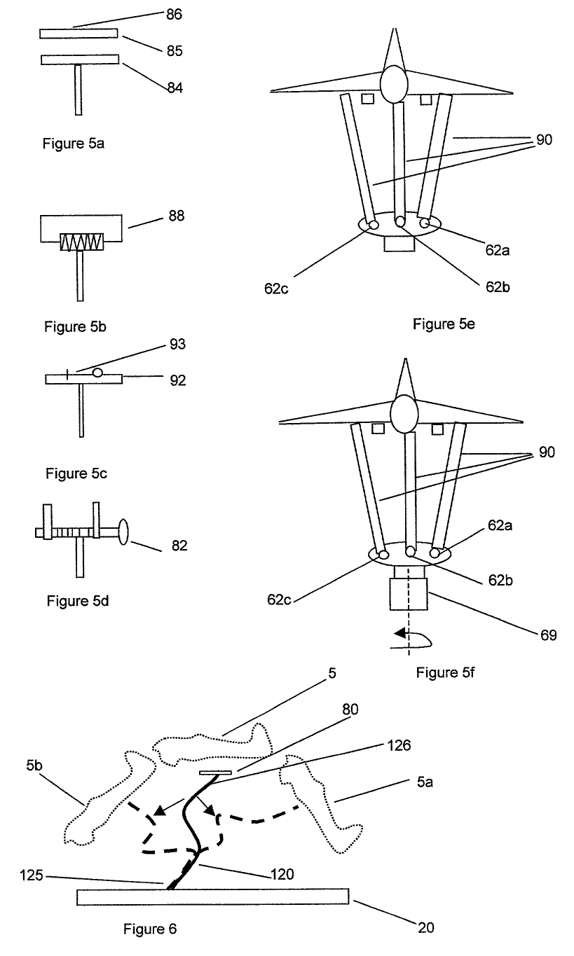

As seen in FIG. 2 and FIG. 4a, the ball within a socket assembly 60 provides the rotational movement for the apparatus 10 of this invention so that a model aerospace craft or vehicle 5 can be positioned along the pitch, yaw and roll axis seen in FIG. 3. One preferred embodiment comprises a ball 62 that rotates up to 180° within the socket 63 so as to position the model aerospace craft 5 along lateral, longitudinal, and vertical axes y, x and z. In another embodiment, the ball 62 can rotate up to 360° along the yaw axis, z, and the limit of rotation along the pitchy, and roll, x, axes is determined by the position of the attaching means 80 on the ball 62. The ball 62 swivels within the socket 63 and can be locked in place with a releasable locking means 64 such as a releasable knob 64. The socket 63 can be integral with the second end of the upright stand as seen in FIG. 1, or alternatively, the socket can be a separate component and attached to the upright stand 40 as in FIG. 2. A universal ball and socket joint assembly with a releasable knob 64 is one preferred ball/socket assembly 60. Other swivel joints are known in the art and within the scope of this invention. The ball's 62 rotation within the socket is limited by the edges of the socket 63 encompassing the ball 62, the higher the edges of the socket, the greater the limitation of the rotation of the ball and its attachment. Preferably, the ball 62 with its attachment can rotate up to 180° within the socket 63 so as to position the model aerospace craft 5 along a lateral axis, a longitudinal axis and a vertical axis. In this way, the ball/socket assembly 60 position the model aerospace craft 5 along a pitch axis, a roll axis and a yaw axis. In an alternative embodiment illustrated in FIG. 4b, the rotation of the model aircraft 5 is provided by a hinged swivel 97 comprising a first section 98, attached to a swivel 69 or a ball and socket assembly 60, and a second section 99 attached to the fuselage 6. In an alternative embodiment of this invention, as seen in FIG. 5f, the apparatus 10 is comprised of an upright stand 40 with a plurality of balls within a socket assemblies 60. Each of the balls 62a, 62b, 62c has one or more prongs 90a, 90b, 90c each fixedly attached. The plurality of prongs 90a, 90b, 90c is each adapted to fixedly attach to the fuselage 6 of the model aerospace craft 5. The ball/socket assemblies 60 are each adapted to rotate the model aerospace craft in the three planes.

In the preferred embodiments of the apparatus 10 for supporting a model aerospace craft 5 in multiple positions, the ball 62 comprises an attaching means 80 to attach the model aerospace craft 5 to the apparatus 10. As illustrated in FIGS. 5a to 5f, this invention embodiments various means of attachment. In FIG. 5d, the attaching means comprises an manually adjustable clamp 82 adapted to fixedly attach to the fuselage 6 of the model aerospace craft. Since it is manually adjustably, the clamp can accommodate various sized fuselages.

In one preferred embodiment, as seen in FIG. 5a, the attaching means 80 comprises a magnetic strip 84 and a magnetic metal bar 85, the magnetic strip 84 can be fixedly attached to the ball 62 and the magnetic metal bar 85 adapted to be fixedly attached to the model aerospace craft by an adhesive or VELCRO® brand hook and loop fasteners 86, for example. FIG. 5b illustrated an attaching means comprising a spring-loaded clamp 88, the spring-loaded clamp 88 can be adapted to clamp onto the fuselage 6 of the model aerospace craft. In another alternative, FIG. 5c, the attaching means comprises a quick release plate 92 and mount 93, the quick release plate 92 can attach to the fuselage 6 and the quick release mount 93 is adapted to attach to the ball 62 within the ball/socket assembly 60. Another embodiment, depicted in FIG. 4, comprises an extension 87 positioned between the attaching means 80 and the ball within the socket assembly 60. The extension 87 provides an increased height and range of motion for the model aerospace craft 5.

To illuminate the model aerospace craft, a preferred embodiment further comprises a light source 95 mounted on the pedestal as illustrated in FIG. 2. Alternatively, the model aerospace craft 5 can be illuminated by a series of lights set in the perimeter of the pedestal 20.

The apparatus for supporting a model aerospace craft in multiple positions can be pre-assembled and sold in a kit so that model aerospace hobbyists can personally assemble it. In this embodiment, the apparatus comprises unassembled components. The unassembled components comprises a pedestal 20, an upright stand 40 having a first end 42 for attachment to the pedestal and a second end 43. The components further comprise a ball within a socket assembly 60 for attachment to the second end 43 of the upright stand 40. Preferably, the ball 62 is at least 180° rotatable within the socket 63 along a lateral axis, a longitudinal axis and a vertical axis. The components further include an attaching means 80 adapted to attach the model aerospace craft to the ball within the socket, the ball and socket and attaching means adapted to rotate the model aerospace craft to simulate pitch, roll and yaw. The unassembled components can be contained within a kit.

The foregoing description is illustrative and explanatory of preferred embodiments of the invention and variations in the size, shape, materials and other details will become apparent to those skilled in the art. It is intended that all such variations and modifications which fall within the scope and spirit of the appended claims be embraced thereby.

1. An apparatus for supporting a model aerospace craft in multiple positions, the model aerospace craft comprising a fuselage, the apparatus comprising:
a pedestal;
an upright stand, the stand having a first end attached to the pedestal and a second end;
a ball within a socket attached to the second end of the upright stand;
attaching means adapted to attach the model aerospace craft to the ball within the socket, the ball and socket adapted to rotate the model aerospace craft in three planes.

2. The apparatus of claim 1 wherein the pedestal comprises a flat base.

3. The apparatus of claim 1 wherein the pedestal comprises a base tripod.

4. The apparatus of claim 1 wherein the upright stand comprises a support column.

5. The apparatus of claim 1 wherein the upright stand comprises a tripod.

6. The apparatus of claim 5 wherein the upright stand comprises a slidably adjustable shaft within the tripod for varying the height of the apparatus.

7. The apparatus of claim 1 wherein the upright stand comprises a tube and a rod assembly, the rod telescoping within the tube to vary the height of the apparatus.

8. The apparatus of claim 1 wherein the ball rotates up to 180° within the socket so as to position the model aerospace craft along a lateral axis, a longitudinal axis and a vertical axis.

9. The apparatus of claim 1 wherein the ball rotates up to 180° within the socket so as to position the model aerospace craft along a pitch axis, a roll axis and a yaw axis.

13. The apparatus of claim 1 wherein the attaching means comprises an manually adjustable clamp adapted to fixedly attach to the fuselage of the model aerospace craft.

14. The apparatus of claim 1 wherein the attaching means comprises two or more prongs, each prong fixedly attached to a separate ball within the socket assembly, the prongs adapted to fixedly attach to the fuselage of the model aerospace craft.

15. The apparatus of claim 1 wherein the attaching means comprises a magnetic strip and a magnetic metal bar, the magnetic strip fixedly attached to the ball within the socket and the magnetic metal bar adapted to be fixedly attached to the model aerospace craft.

16. The apparatus of claim 1 wherein the attaching means comprises a hinge having a first section, and a second section, the first section attached to the pedestal and the second section attached to the ball within a socket assembly.

17. The apparatus of claim 1 wherein the attaching means comprises a spring-loaded clamp, the spring-loaded clamp adapted to clamp onto the fuselage of the model aerospace craft.

18. The apparatus of claim 1 wherein the attaching means comprises a quick release plate and mount, the quick release plate adapted to attach to the fuselage of a model aerospace craft and the quick
release mount attached to the ball within the socket.

19. The apparatus of claim 1 further comprising a light source mounted on the pedestal.

20. An apparatus for supporting a model aerospace craft in multiple positions, the model aerospace craft comprising a fuselage, the apparatus comprising:
a pedestal;
an upright stand, the stand having a first end attached to the pedestal and a second end;
a ball within a socket attached to the second end of the upright stand, the ball at least 180° rotatable within the socket along a lateral axis, a longitudinal axis and a vertical axis;
attaching means adapted to attach the model aerospace craft to the ball within the socket, the ball and socket and attaching means adapted to rotate the model aerospace craft to simulate pitch, roll and yaw; and
an extension positioned between the attaching means and the ball within a socket assembly.

21. The apparatus of claim 20 wherein the pedestal comprises a height adjustable means.

22. The apparatus of claim 20 wherein the upright stand comprises a height adjustable means.

23. The apparatus of claim 20 wherein the attaching means comprises a magnetic strip and a magnetic metal bar, the magnetic strip fixedly attached to the ball within the socket and the magnetic bar adapted to be fixedly attached to the model aerospace craft.

24. The apparatus of claim 20 wherein the attaching means comprises
a spring-loaded clamp, the spring-loaded clamp adapted to clamp onto the fuselage of the model aerospace craft.

25. The apparatus of claim 20 wherein the attaching means comprises
a quick release plate and mount, the quick release plate adapted to attach to the fuselage of a model aerospace craft and the quick release mount attached to the ball within the socket.

26. The apparatus of claim 20 wherein the attaching means comprises a plurality of prongs each fixedly attached to a ball within a socket, the prongs each adapted to fixedly attach to the fuselage of the model aerospace craft.

27. An apparatus for supporting a model aerospace craft in multiple positions, the model aerospace craft comprising a fuselage, the apparatus comprising:
a pedestal;
an upright stand, the stand having a first end attached to the pedestal and a second end;
a plurality of balls within a socket attached to the second end of the upright stand;
attaching means adapted to attach the model aerospace craft to the balls within a socket, the balls within a socket each adapted to rotate the model aerospace craft in three planes.

28. An apparatus for supporting a model aerospace craft in multiple positions, the model aerospace craft comprising a fuselage, the apparatus comprising:
a pedestal;
an upright stand, the upright stand comprising a flexible gooseneck support
the gooseneck support comprising a first end and a second end, the first end attached to the pedestal and the second end adapted to attach to the fuselage.

29. An apparatus for supporting a model aerospace craft in multiple positions, the model aerospace craft comprising a fuselage, the apparatus comprising:
unassembled components, the unassembled components comprising:
a pedestal;
an upright stand, the stand having a first end for attachment to the pedestal and a second end;
a ball within a socket for attachment to the second end of the upright stand, the ball at least 180° rotatable within the socket along a lateral axis, a longitudinal axis and a vertical axis;
attaching means adapted to attach the model aerospace craft to the ball within the socket, the ball and socket and attaching means adapted to rotate the model aerospace craft to simulate pitch, roll and yaw; and
a kit to contain the unassembled components.
